(19) United States
(12) Patent Application Publication
(10) Pub. No.: US 2017/0239746 A1
(43) Pub. Date: Aug. 24, 2017

(54) REVERSIBLE CONTACT TIPS AND WELDING ASSEMBLIES FOR REVERSIBLE CONTACT TIPS

(71) Applicant: Illinois Tool Works Inc., Glenview, IL (US)

(72) Inventor: Robert J. Centner, Frankfort, IL (US)

(21) Appl. No.: 15/434,248

(22) Filed: Feb. 16, 2017

Related U.S. Application Data
(60) Provisional application No. 62/296,958, filed on Feb. 18, 2016.

(51) Int. Cl. B23K 9/12; B23K 9/173; B23K 9/29

(52) U.S. Cl. CPC B23K 9/123; B23K 9/295; B23K 9/173

(57) ABSTRACT

Reversible contact tips and welding assemblies for reversible contact tips are disclosed. An example welding contact tip includes a first axial end portion having a welding wire outlet of an inner bore of the welding contact tip, a threaded middle portion adjacent the first axial end portion, wherein the threaded middle portion comprises external threads configured to mate with internal threads of a gas diffuser of a welding torch, and a second axial end portion adjacent the threaded middle portion.

### RELATED APPLICATIONS

This patent application claims priority to U.S. Provisional Patent Application Ser. No. 62/296,958, filed Feb. 18, 2016, entitled “Reversible Contact Tip.” The entirety of U.S. Provisional Patent Application Ser. No. 62/296,958 is incorporated herein by reference.

### BACKGROUND

The present disclosure relates generally to welding systems and, more particularly, to contact tips for use in welding torches of welding systems.

Welding is a process that has increasingly become ubiquitous in various industries and applications. Additionally, as welding has increased in general, automated welding processes are also becoming increasingly popular. With increasing automation in the field of welding, simple designs to meet automation maintenance goals are ever more valuable. For example, automation complexity may decrease as maintenance complexity of the welding systems also decreases.

Therefore, it may be advantageous to provide a mechanism that simplifies replacement and securement of components within welding systems that are frequently replaced. The present subject matter provides a mechanism for replacement and securement of contact tips within a welding system.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In certain embodiments, a welding contact tip includes a first axial end portion having a first welding wire opening of an inner bore of the welding contact tip; and a second axial end portion having a second welding wire opening of the inner bore of the welding contact tip, the welding contact tip being reversible such that the first welding wire opening is an input opening for a welding wire when the second welding wire opening is an output opening for the welding wire and the second welding wire opening is the input opening for the welding wire when the first welding wire opening is the output opening for the welding wire.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an embodiment of a metal inert gas (MIG) welding system with a power source and a wire feeder, in accordance with aspects of this disclosure.

FIG. 2 is a side view of an embodiment of a welding torch of the MIG welding system of FIG. 1, in accordance with aspects of this disclosure.

FIG. 3 is a cross-sectional perspective view of a portion of the welding torch of FIG. 2, in accordance with aspects of this disclosure.

FIG. 4 is a cross-sectional side view of the portion of the welding torch of FIG. 3, in accordance with aspects of this disclosure.

FIG. 5 is an exploded view of the portion of the welding torch of FIG. 3, in accordance with aspects of this disclosure.

FIG. 6 is an exploded cross-sectional side view of the portion of the welding torch of FIG. 3, in accordance with aspects of this disclosure.

FIG. 7 is a cross-sectional perspective view of another implementation of the welding torch of FIG. 2, in accordance with aspects of this disclosure.

FIG. 8 is an exploded view of the portion of the welding torch of FIG. 7, in accordance with aspects of this disclosure.

FIG. 9 is an exploded cross-sectional side view of the portion of the welding torch of FIG. 7, in accordance with aspects of this disclosure.

The figures are not necessarily to scale. Where appropriate, similar or identical reference numbers are used to refer to similar or identical components.

### DETAILED DESCRIPTION

One or more embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

A metal inert gas (MIG) or gas metal arc welding (GMAW) welding gun is adapted with a threaded end to accept MIG welding consumables. Example consumables include a contact tip holder, a contact tip, a contact tip cap, and a gas nozzle, among others. Disclosed contact tip holders have threads on one end to mate with the threaded end of the MIG gun. Disclosed contact tip holders have a tapered seat area on one end to mate with the contact tip. The tip holder also has a threaded portion adjacent to the tapered seat area to mate with a threaded portion of the tip cap.

In some examples, the contact tip holder is configured to contain a MIG gun liner, which delivers the welding wire, within the MIG gun. In some examples, the contact tip holder aligns the MIG gun liner with the contact tip. In some examples, the contact tip holder directs welding shielding gas from the MIG gun to an area under the tip cap. In some examples, the contact tip holder includes mechanical and electrical connections between the contact tip and the MIG gun. In some examples, the contact tip holder provides mechanical and electrical connections of the contact tip cap and the MIG gun. In some examples, the contact tip holder includes a mechanical connection of the gas nozzle to the MIG gun.

In some examples, the contact tip provides a welding wire (e.g., an electrode wire) to the weld pool/puddle. In some examples, the contact tip transfers weld current to the welding wire.

In some examples, the contact tip cap includes mechanical and electrical connections between the contact tip and the MIG gun. In some examples, the contact tip cap shields the contact tip from the weld environment. In some examples, the contact tip cap directs shielding gas outward into the inner bore of the gas nozzle.

In some examples, the gas nozzle includes a mechanical connection to the MIG gun. In some examples, the gas nozzle directs shielding gas towards the weld pool/puddle. In some examples, the gas nozzle insulates itself from the weld current.

Disclosed example contact tip caps are symmetrical. For example, both halves of a contact tip may have identical shapes and/or features and enable the contact tip to be attached to the MIG gun in either a forward or reversed direction.

In some examples, a contact tip is attached to the MIG gun by compressing the contact tip between a tip holder and a tip cap. Because the contact tip is symmetrical, either orientation permits operation. In some examples, the contact tip holder and the contact tip cap mate together via a threaded connection. The tip holder has a seat to mate with either end of the contact tip. The contact tip cap has a similar seat to mate with either end of the contact tip. As the contact tip cap is threaded onto the contact tip holder, the contact tip is secured in place and an electrical connection is established.

The contact tip cap is configured such that the contact tip cap encapsulates the contact tip and shields the contact tip from the weld environment. In some examples, only the very end face of the contact tip is exposed. The contact tip cap is configured such that there is an air-space created between the inside surfaces of the contact tip cap and external surfaces of the contact tip. The contact tip cap may be also configured such that weld shielding gas flows within this air-space prior to exiting the tip cap.

The symmetrical design of the contact tip allows for it to be installed in either direction, which provides extended tip life. As a contact tip is used during the welding process, the contact tip tends to mechanically wear at a faster pace on the end closest to the welding arc. This end of the contact tip is where most of the weld current is transferred from the contact tip to the welding wire and thus the mechanical condition of the tip inner bore at this point is critical. At some point, the tip bore wears enough on this end such that the welding arc is affected negatively. In conventional designs, the contact tip is removed, discarded, and replaced by a new tip. In contrast, disclosed example contact tips enable the tip to be installed in either direction, such that one can now remove a worn tip, flip to an opposite orientation, and re-attach the contact tip to the MIG gun. Such a reversal process promotes additional use of the contact tip beyond that of conventional tip designs.

The welding process generates extremely high temperatures near the weld arc. Also, molten metal droplets (e.g., weld spatter) are commonly generated about the weld arc, projecting outward and attaching to exposed surfaces of the welding gun consumables (tip, nozzle, and diffuser). Conventional tip designs have a good portion of the contact tip completely exposed to the radiant heat and weld spatter of the welding environment. The high temperatures the exposed tip surfaces are subjected to lead to softening (e.g., annealing) of the typically copper contact tips. Such softening speeds up the mechanical wearing of the tip inner bore, which shortens the tip life. By encapsulating all but just the end face of the contact tip inside the tip cap, the tip operates at lower temperatures and, as a result, does not soften as quickly. Similarly, protecting the tip surfaces from molten metal droplets should help keep tip temperatures lower. In either case, lower tip temperatures should help to extend contact tip life.

In some examples, the contact tip operates at lower temperatures by forcing shielding gas to flow about a good portion of the outside diameter of the tip. In theory, this passing shielding gas removes heat from the tip via forced convection.

In some examples, the contact tip cap better resists weld spatter. This could help prevent weld porosity problems due to obstructed gas flow. The tip cap can be made of materials other than copper (such as brass or a ceramic) that better resist attachment of weld spatter. Portions of the contact tip that are exposed to the arc through the contact tip cap may be provided with an anti-spatter coating to further resist spatter.

In some examples, the contact tip shape is simplified, which provides for faster machining and reduced costs to manufacture. By performing the same machining operations on either end of the tip, the number of differing operations are reduced. The reduction in different machining operations minimizes the number of tools and/or tooling stations required during the machining process. Machining time and costs are reduced relative to conventional contact tips.

In some examples, the gas nozzle is retained on the MIG gun relative to conventional gas nozzles, which improves the physical security of the gas nozzle as the nozzle wears during use. The inner bore of typical slip-on nozzles tends to wear during use. The wear results from repeated installation and removal of the nozzle. As the bore wears, the friction force applied via typical retaining methods is lessened and the nozzles may come loose or fall off the MIG gun. The proposed design lessens the wear on the nozzle inner bore and provides additional retention force to help keep the nozzle secure.

While example tapers are disclosed, other sizes and/or angles of the tapers may be used for the contact tip. In some examples, the tapered tip ends may be replaced with radiused ends. In some examples, the tapered tip ends may be replaced with flat ends.

Some examples have male threads on the tip cap and mating female threads on the tip holder. In some examples, the nozzle attaches via a threaded connection with the contact tip holder.

In some examples, the connection between the tip cap and tip holder has a shoulder to engage with a step inside the nozzle assembly. The nozzle assembly may have a threaded portion configured to engage with a mating, threaded portion of the tip holder. As the nozzle assembly is threaded onto the tip holder, the nozzle internal step engages with the tip cap shoulder and urges the tip cap towards the tip holder. The contact tip is secured between the tip holder and tip cap when the nozzle is fully installed, creating a mechanical/electrical connection of the contact tip to the MIG gun.

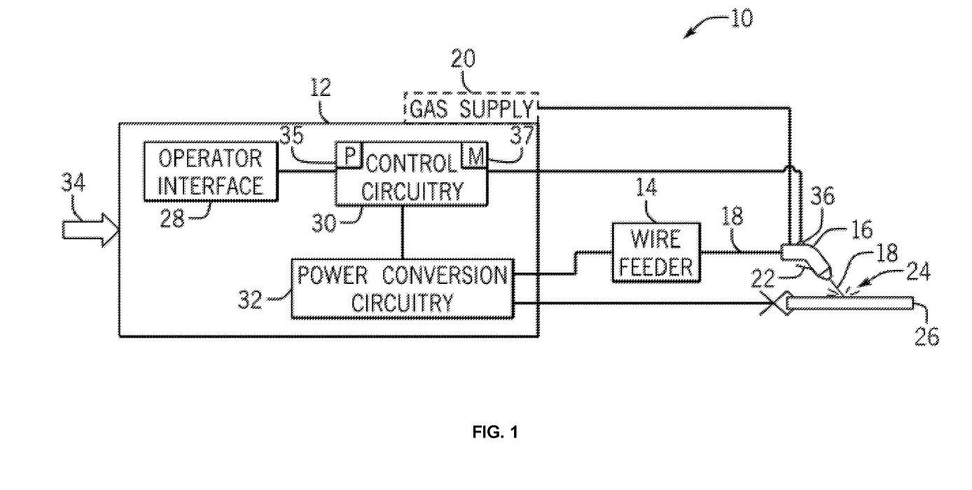

Turning now to the drawings, and referring first to FIG. 1, a welding system 10 is illustrated as including a power source 12 coupled to a wire feeder 14. In the illustrated embodiment, the power source 12 is separate from the wire feeder 14, such that the wire feeder 14 may be positioned at some distance from the power source 12 near a welding location. However, it should be understood that the wire feeder 14, in some implementations, may be integral with the power source 12. The power source 12 may supply weld power to a torch 16 through the wire feeder 14, or the power source 12 may supply weld power directly to the torch 16. The wire feeder 14 supplies a wire electrode 18 (e.g., solid wire, cored wire, coated wire) to the torch 16. A gas supply 20, which may be integral with or separate from the power source 12, supplies a gas (e.g., CO₂, argon) to the torch 16. An operator may engage a trigger 22 of the torch 16 to initiate an arc 24 between the electrode 18 and a work piece 26. In some embodiments, the welding system 10 may be triggered by an automation interface including, but not limited to, a programmable logic controller (PLC) or robot controller. The welding system 10 is designed to provide welding wire (e.g., electrode 18), weld power, and shielding gas to the welding torch 16. As will be appreciated by those skilled in the art, the welding torch 16 may be of many different types, and may facilitate use of various combinations of electrodes 18 and gases.

The welding system 10 may receive data settings from the operator via an operator interface 28 provided on the power source 12. The operator interface 28 may be incorporated into a faceplate of the power source 12, and may allow for selection of settings such as the weld process (e.g., stick, TIG, MIG), the type of electrode 18 to be used, voltage and current settings, transfer mode (e.g., short circuit, pulse, spray, pulse), and so forth. In particular, the welding system 10 allows for MIG welding (e.g., pulsed MIG welding) with electrodes 18 (e.g., welding wires) of various materials, such as steel or aluminum, to be channeled through the torch 16. The weld settings are communicated to control circuitry 30 within the power source 12.

The control circuitry 30 operates to control generation of welding power output that is applied to the electrode 18 by power conversion circuitry 32 for carrying out the desired welding operation. For example, in some embodiments, the control circuitry 30 may be adapted to regulate a pulsed MIG welding regime that may have aspects of short circuit transfer and/or of spray transfer of molten metal from the welding wire to a molten weld pool of a progressing weld. Such transfer modes may be controlled during operation by adjusting operating parameters of current and voltage pulses for arcs 24 developed between the electrode 18 and the work piece 26.

The control circuitry 30 is coupled to the power conversion circuitry 32, which supplies the weld power (e.g., pulsed waveform) that is applied to the electrode 18 at the torch 16. The power conversion circuitry 32 is coupled to a source of electrical power as indicated by arrow 34. The power applied to the power conversion circuitry 32 may originate in the power grid, although other sources of power may also be used, such as power generated by an engine-driven generator, batteries, fuel cells or other alternative sources. Components of the power conversion circuitry 32 may include choppers, boost converters, buck converters, inverters, and so forth.

The control circuitry 30 controls the current and/or the voltage of the weld power supplied to the torch 16. The control circuitry 30 may monitor the current and/or voltage of the arc 24 based at least in part on one or more sensors 36 within the wire feeder 14 or torch 16. In some embodiments, a processor 35 of the control circuitry 30 determines and/or controls the arc length or electrode extension based at least in part on feedback from the sensors 36. The arc length is defined herein as the length of the arc between the electrode 18 and the work piece 26. The processor 35 determines and/or controls the arc length or electrode extension utilizing data (e.g., algorithms, instructions, operating points) stored in a memory 37. The data stored in the memory 37 may be received via the operator interface 28, a network connection, or preloaded prior to assembly of the control circuitry 30. Operation of the power source 12 may be controlled in one or more modes, such as a constant voltage (CV) regulation mode in which the control circuitry 30 controls the weld voltage to be substantially constant while varying the weld current during a welding operation. That is, the weld current may be based at least in part on the weld voltage. Additionally, or in the alternative, the power source 12 may be controlled in a current control mode in which the weld current is controlled independent of the weld voltage. In some embodiments, the power source 12 is controlled to operate in a constant current (CC) mode where the control circuitry 30 controls the weld current to be substantially constant while varying the weld voltage during a welding operation.

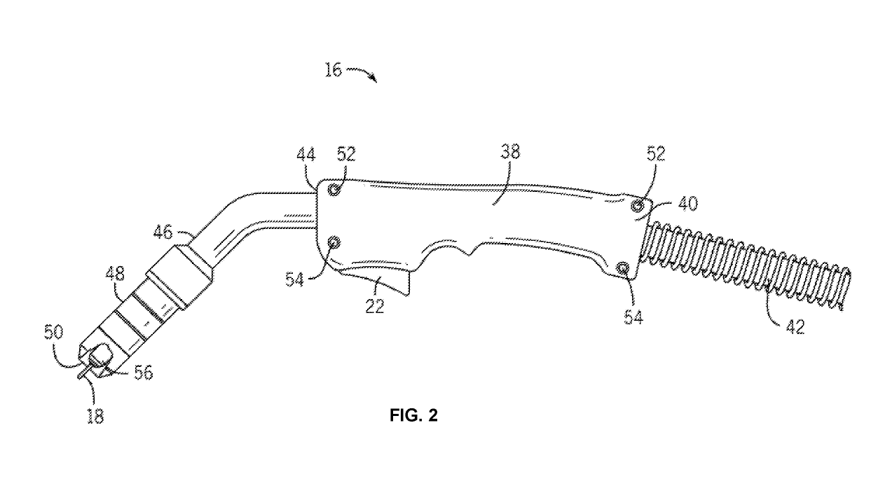

FIG. 2 illustrates an embodiment of the torch 16 of FIG. 1. As discussed in relation to FIG. 1, the torch 16 includes the trigger 22 for initiating a weld and supplying the electrode 18 to the weld. Specifically, the trigger 22 is disposed on a handle 38. A welding operator holds the handle 38 when performing a weld. At a first end 40, the handle 38 is coupled to a cable 42 where welding consumables (e.g., the electrode, the shielding gas, and so forth) are supplied to the weld. Welding consumables generally travel through the handle 38 and exit at a second end 44, which is disposed on the handle 38 at an end opposite from the first end 40.

The torch 16 includes a neck 46 extending out of the second end 44 of the handle 38. As such, the neck 46 is coupled between the handle 38 and a welding nozzle 48. As should be noted, when the trigger 22 is pressed or actuated, welding wire (e.g., electrode 18) travels through the cable 42, the handle 38, the neck 46, and the welding nozzle 48, so that the welding wire extends out of an end 50 (i.e., torch tip) of the welding nozzle 48. Further, as illustrated in FIG. 2, the handle 38 is secured to the neck 46 via fasteners 52 and 54, and to the cable 42 via fasteners 52 and 54. The welding nozzle 48 is illustrated with a portion of the welding nozzle 48 removed to show the electrode 18 extending out of a contact tip 56 that is disposed within the welding nozzle 48.

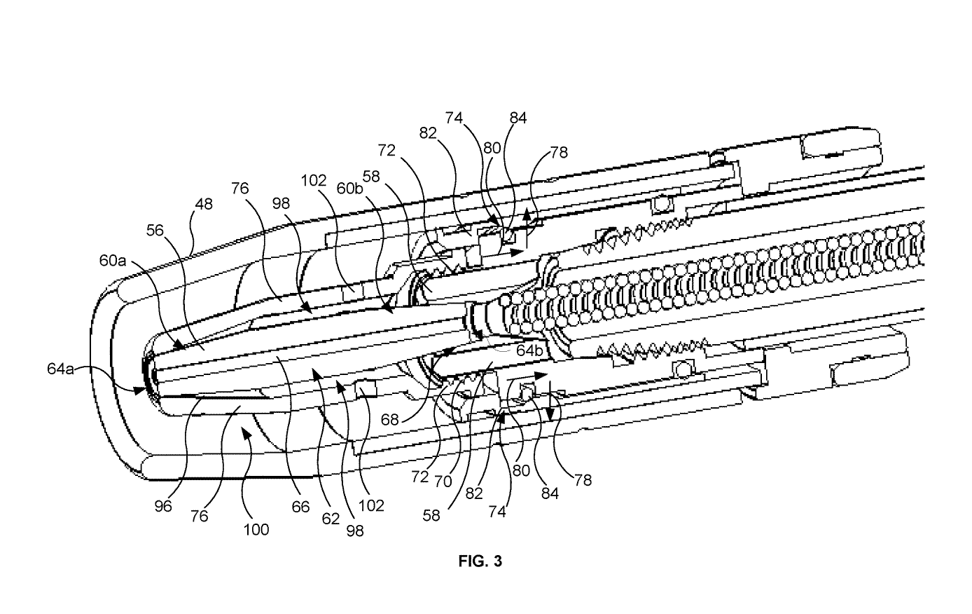

FIG. 3 is a cross-sectional perspective view of a portion of the welding torch 16 of FIG. 2. As illustrated, a contact tip holder 58 receives the contact tip 56 during replacement of the contact tip 56, facilitates mechanical coupling to the welding torch 16 for the contact tip 56, and facilitates electrical coupling to the power source 12 for the contact tip 56, as discussed in detail below.

The contact tip 56 includes two end portions 60a and 60b, and a middle portion 62. The two end portions 60a and 60b taper from the middle portion 62 toward a respective end surface 64a and 64b. An inner bore 66 extends the length of the contact tip 56. The contact tip 56 is reversible in that either of the two ends 60a and 60b of the contact tip 56 can be positioned toward where the welding arc will occur. In some examples, the reversible quality of the contact tip 56 extends the life of the contact tip 56 by enabling both ends 60a and 60b to be used prior to replacing or discarding of the contact tip 56, instead of just one end of conventional contact tips that are usable prior to being replaced or discarded.

The contact tip holder 58 includes a seat 68 that holds one of the end portions 60a, 60b of the contact tip 56. In the illustrated example, the seat 68 holds the end portion 60b. The contact tip holder 58 further includes external threading 70 that mates with internal threading 72 of a contact tip cap 76. The contact tip cap 76 also includes a seat 96 that holds another of the end portions 60a, 60b of the contact tip 58. In the illustrated example, the seat 96 of the contact tip cap 76 holds the end portion 60a. The seat 96 has a larger taper than the taper of the end portions 60a, 60b.

The contact tip cap 76 may be screwed or threaded into a locking connection with the contact tip holder 58 (e.g., via the threading 70, 72) such that the contact tip 56 is seated in both of the seats 68, 96 of the contact tip cap 76 and the contact tip holder 58 with a compression fit. As a result, the contact tip 56 is rigidly held by the contact tip cap 76 and the contact tip holder 58 so that the wire electrode 18 can be pushed through the contact tip 56.

An inner surface of the contact tip cap 76 and an outer surface of the contact tip 56 form an annular region 98. The contact tip holder 58 includes gas ports facilitate movement of shielding gas to a welding site (e.g., through the welding torch 16 into an internal volume 100 formed between the welding nozzle 48 and the contact tip cap 56). The contact tip holder 58 may also include a compressible member 74, such as a compressible circumferential ring. The welding nozzle 48 is axially pushed onto the contact tip holder 58, as illustrated by arrow 80. In certain embodiments, the compressible member 74 may be a rubber or steel rings mounted about an outer circumference of the contact tip holder 58. In its relaxed state, the compressible member 74 may have an outer diameter that is slightly larger than an inner diameter of a portion of the welding nozzle 48 that abuts the compressible member 74 when the welding nozzle 48 is secured to the contact tip holder 58. As the welding nozzle 48 is pushed onto the contact tip holder 58, the compressible member 74 radially compresses, allowing the welding nozzle 48 to be installed over the compressible member 74 and fully onto the contact tip holder 58. The compressible member 74 remains in a compressed state as long as the welding nozzle 48 is installed on the contact tip holder 58. In the compressed state, the compressible member 74 continuously applies a radial force against the internal bore of the welding nozzle 48, as illustrated by arrows 78.

However, the embodiments described herein do not rely solely on this radial force 78 to provide axial friction to prevent the welding nozzle 48 from sliding off the contact tip holder 58 during use. One reason for this is that relying on axial friction alone to retain the welding nozzle 48 to the contact tip holder 58 would present certain drawbacks. For example, over time, the friction force might inevitably lessen, allowing the welding nozzle 48 to fall off of the contact tip holder 58. More specifically, the compressible member 74 may wear away over time due to repeated installations/removals encountered during normal use. To mitigate these drawbacks, as illustrated in FIG. 3, in certain embodiments, the internal bore of the welding nozzle 48 does not have a constant diameter along its engagement length with the contact tip holder 58, but instead includes an internal bore that allows the compressible member 74 to apply an axial retention force, as illustrated by arrows 80, in addition to the frictional force. More specifically, in certain embodiments, the internal bore of the welding nozzle 48 includes an inner circumferential groove 82 having a tapered surface 84 against which the compressible member 74 interfaces when the welding nozzle 48 is installed onto the contact tip holder 58.

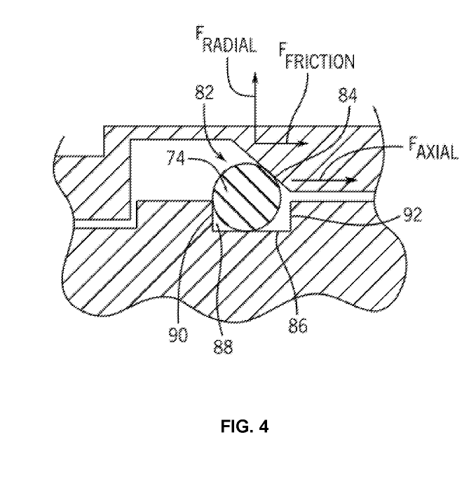

FIG. 4 is a cutaway side view of the portion of the welding torch 16 illustrated in FIG. 3. As illustrated, when the welding nozzle 48 is secured to the contact tip holder 58, the compression member 74 is radially compressed between the tapered surface 84 of the inner circumferential groove 82 of the welding nozzle 48 and an outer surface 86 of the contact tip holder 58 that forms an outer circumferential groove 88 with adjacent walls 90, 92 that extend radially outward from opposite sides of the outer surface 86. As such, the compression member 74 creates a radially outward force F_{radial}, which creates an axial friction force F_{force} that at least partially holds the welding nozzle 48 in place with respect to the contact tip holder 58. In addition, when the welding nozzle 48 is secured to the contact tip holder 58, the compression member 74 is axially compressed between the tapered surface 84 of the inner circumferential groove 82 of the welding nozzle 48 and the first wall 90 of the outer circumferential groove 88 of the contact tip holder 58. As such, the compression member 74 creates an axial force Fₐₓᵢₐₗ that at least partially holds the welding nozzle 48 in place with respect to the contact tip holder 58.

The example contact tip cap 76 further includes gas ports to facilitate gas transfer from the annular region 98 to the internal volume 100, from which the gas can be expelled from the gas nozzle 48 to the site of the weld.

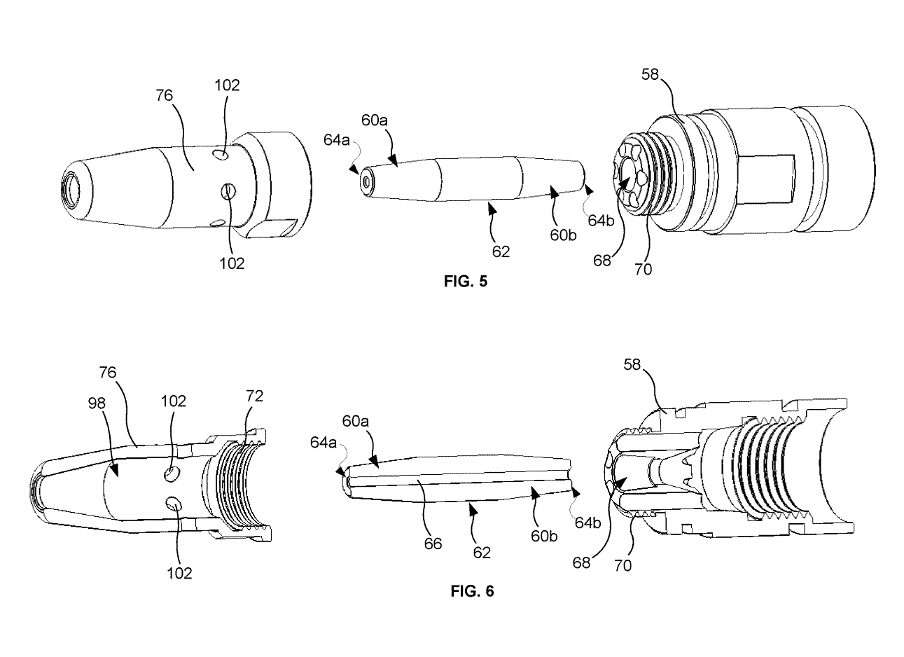

FIG. 5 is an exploded view of a portion of the welding torch of FIG. 2, in accordance with this disclosure. FIG. 6 is an exploded cross-sectional side view of a portion of the welding torch of FIG. 2, in accordance with this disclosure.

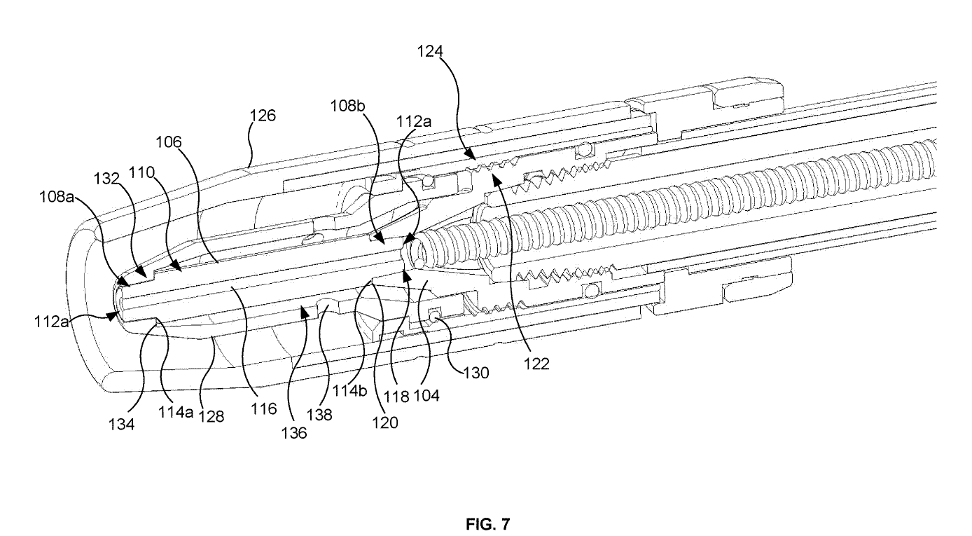

FIG. 7 is a cross-sectional perspective view of another implementation of the welding torch 16 of FIG. 2. As illustrated in FIG. 7, a contact tip holder 104 receives a contact tip 106 during replacement of the contact tip 106, facilitates mechanical coupling to the welding torch 16 for the contact tip 106, and facilitates electrical coupling to the power source 12 for the contact tip 106, as discussed in detail herein.

The contact tip 106 includes two end portions 108a and 108b, and a middle portion 110. In contrast with the two end portions 60a and 60b of FIGS. 3, 5, and 6, the end portions 108a and 108b do not taper from the middle portion 110 toward respective end surfaces 112a and 112b. Instead, the end portions 108a and 108b are separated from the middle portion 110 by respective shoulders 114a and 114b. An inner bore 116 extends the length of the contact tip 106. The contact tip 106 is reversible in that either of the two ends 108a and 108b of the contact tip 106 can be positioned toward where the welding arc will occur. In some examples, the reversible quality of the contact tip 106 extends the life of the contact tip 106 by enabling both ends 108aa and 108bb to be used (e.g., consumed) prior to replacing or discarding of the contact tip 106, instead of just one end of conventional contact tips that are usable prior to being replaced or discarded.

The contact tip holder 104 includes a seat 118 that holds one of the end portions 108a, 108b of the contact tip 106. In the illustrated example, the seat 118 holds the end portion 108b via an opposing shoulder 120. The contact tip holder 104 further includes external threading 122 that mates with internal threading 124 of a nozzle 126.

In contrast with the example implementation of the contact tip assembly described above with reference to FIG. 3, a contact tip cap 128 is incorporated into the nozzle 126 as a removable component of the nozzle 126. The example contact tip cap 128 is secured into the nozzle 126 via a compressible spring ring 130. However, other attachment or securing methods may be used instead of the compressible spring ring 130. When the nozzle 126 is threaded onto the contact tip holder 104, the nozzle 126 secures the contact tip cap 128.

The contact tip cap 128 also includes a seat 132 that holds another of the end portions 108a, 108b of the contact tip 106. In the illustrated example, the seat 132 of the contact tip cap 132 holds the end portion 108a. The seat 132 has an opposing shoulder 134 to contact the shoulder 114a of the contact tip 106.

When the nozzle 126 is screwed or threaded into a locking connection with the contact tip holder 104 (e.g., via the threading 122, 124) the contact tip 106 is seated and compressed between the seats 132 of the contact tip cap 128 and the seat 118 of the contact tip holder 104. As a result, the contact tip 106 is rigidly held by the contact tip cap 128 and the contact tip holder 108 so that the wire electrode 18 can be pushed through the contact tip 106.

An inner surface of the contact tip cap 128 and an outer surface of the contact tip 106 form an annular region 136. The contact tip holder 104 includes gas ports 138 that facilitate movement of shielding gas to a welding site (e.g., through the welding torch 16 into an internal volume 100 formed between the nozzle 126 and the contact tip cap 128).

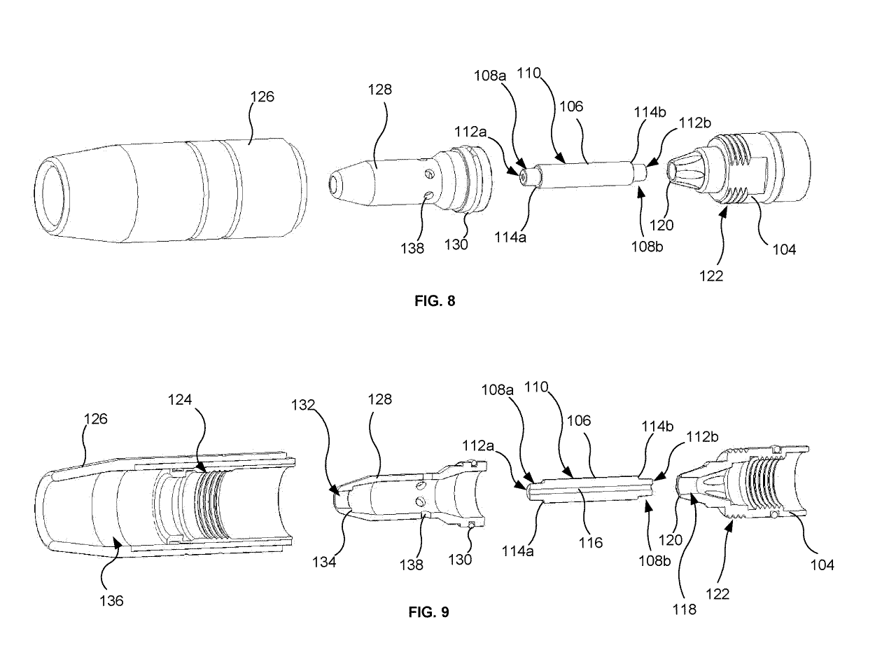

FIG. 8 is an exploded view of the portion of the welding torch of FIG. 7. FIG. 9 is an exploded cross-sectional side view of the portion of the welding torch of FIG. 7.

The example contact tip caps 76, 128 and the contact tips 56, 106 are configured so that the end surfaces 64a, 64, 112a, 112b of the reversible contact tips 56, 106 that are exposed by the contact tip caps 76, 128 are substantially flush with an end surface of the reversible contact tip 76, 128.

Disclosed example contact tips, contact tip caps, contact tip holders, nozzles and/or, more generally, welding torch assemblies are configured for toolless installation of the contact tips, contact tip caps, contact tip holders, and/or nozzles, and/or toolless changing of the contact tips, contact tip caps, contact tip holders, and/or nozzles. As used herein, the term “toolless” refers to capable of being done by hand and/or without the use of torque-enhancing tools such as wrenches.

The contact tips 56, 106 may be provided with external threading to enable the contact tips 56, 106 to be secured to internal threading of the contact tip cap 76, 128 and/or to the contact tip holder 58, 104 (e.g., in the seats of the contact tip cap 76, 128 and/or to the contact tip holder 58, 104) prior to securing of the contact tip cap 76, 128 to the contact tip holder 58, 104.

Example welding contact tips include a first axial end portion having a first welding wire opening of an inner bore of the welding contact tip and a second axial end portion having a second welding wire opening of the inner bore of the welding contact tip, the welding contact tip being reversible such that the first welding wire opening is an input opening for a welding wire when the second welding wire opening is an output opening for the welding wire and the second welding wire opening is the input opening for the welding wire when the first welding wire opening is the output opening for the welding wire.

Some example welding contact tips further include a middle portion between the first axial end portion and the second axial end portion.

In some examples, the first axial end portion and the second axial end portion are tapered and the middle portion does not taper.

In some examples, the first axial end portion and the second axial end portion are non-threaded.

In some examples, a first end surface and a second end surface of the welding contact tip comprise an anti-spatter coating.

In some examples, the first axial end portion and the second axial end portion are not tapered, and the first axial end portion comprises a shoulder between the first axial end portion and a middle portion.

In some examples, the welding contact tip has reflectional symmetry across a plane perpendicular to the inner bore of the welding contact tip. Additionally or alternatively, the welding contact tip may have rotational symmetry about the inner bore of the contact tip.

In some examples, the first axial end portion and the second axial end portion comprise external threads positioned between the ends of the welding contact tip. The external threads may be used to secure the welding contact tip to the contact tip cap and/or the contact tip holder.

Example welding gun assemblies include a reversible contact tip comprising a first axial end portion and a second axial end portion opposite the first axial end portion, an inner bore extending through the reversible contact tip between the first axial end portion and the second axial end portion; a contact tip holder comprising a first seat to receive one of the first axial end portion or the second axial end portion; and a contact tip cap comprising a second seat to receive the other of the first axial end portion or the second axial end portion and, when the contact tip cap is connected to the contact tip holder, to rigidly hold the reversible contact tip in cooperation with the first seat of the contact tip holder.

In some examples, the first axial end portion has a first taper angle, the second axial end portion has the first taper angle, and the seat of the contact tip cap has a second taper angle, the second taper angle being steeper than the first taper angle.

In some examples, the contact tip cap holds the reversible contact tip such that the one of the first axial end portion of the second axial end portion in contact with the contact tip cap has an end surface that is substantially flush with an end surface of the contact tip cap.

In some examples, an inner surface of the contact tip cap is threaded, an outer surface of the contact tip holder is threaded, and the inner surface of the contact tip cap and the outer surface of the contact tip holder are connected to rigidly hold the reversible contact tip.

In some examples, the reversible contact tip further comprises a middle portion between the first axial end portion and the second axial end portion, the contact tip holder comprises first gas ports to permit gas flow into an annular region between the middle portion of the reversible contact tip and the contact tip cap, and the contact tip cap comprises second gas ports to permit gas flow from the annular region.

In some examples, the contact tip cap is configured such that gas flow from the contact tip holder to the second gas ports via the annular region removes heat from the reversible contact tip.

In some examples, the contact tip cap is configured to protect at least a portion of the first axial end portion or the second axial end portion in contact with the second seat.

In some examples, the contact tip holder and the contact tip cap are configured for toolless changing or installation of the reversible contact tip.

In some examples, the contact tip cap is configured to hold the reversible contact tip such that an end surface of the reversible contact tip exposed by the contact tip cap and having an opening of the inner bore is substantially flush with an end surface of the reversible contact tip.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A welding contact tip comprising:
a first axial end portion having a first welding wire opening of an inner bore of the welding contact tip; and
a second axial end portion having a second welding wire opening of the inner bore of the welding contact tip, the welding contact tip being reversible such that the first welding wire opening is an input opening for a welding wire when the second welding wire opening is an output opening for the welding wire and the second welding wire opening is the input opening for the welding wire when the first welding wire opening is the output opening for the welding wire.

2. The welding contact tip of claim 1, further comprising a middle portion between the first axial end portion and the second axial end portion.

3. The welding contact tip of claim 2, wherein the first axial end portion and the second axial end portion are tapered and the middle portion does not taper.

4. The welding contact tip of claim 1, wherein the first axial end portion and the second axial end portion are non-threaded.

5. The welding contact tip of claim 1, wherein a first end surface and a second end surface of the welding contact tip comprise an anti-spatter coating.

6. The welding contact tip of claim 1, wherein the first axial end portion and the second axial end portion are not tapered, and the first axial end portion comprises a shoulder between the first axial end portion and a middle portion.

7. The welding contact tip of claim 1, wherein the welding contact tip has reflectional symmetry across a plane perpendicular to the inner bore of the welding contact tip.

8. The welding contact tip of claim 1, wherein the first axial end portion and the second axial end portion comprise external threads positioned between the ends of the welding contact tip.

9. A welding gun assembly, comprising:
a reversible contact tip comprising a first axial end portion and a second axial end portion opposite the first axial end portion, an inner bore extending through the reversible contact tip between the first axial end portion and the second axial end portion;
a contact tip holder comprising a first seat configured to receive one of the first axial end portion or the second axial end portion; and
a contact tip cap comprising a second seat configured to receive the other of the first axial end portion or the second axial end portion and, when the contact tip cap is connected to the contact tip holder, configured to rigidly hold the reversible contact tip in cooperation with the first seat of the contact tip holder.

10. The welding gun assembly of claim 9, wherein the first axial end portion has a first taper angle, the second axial end portion has the first taper angle, and the second seat of the contact tip cap has a second taper angle, the second taper angle being steeper than the first taper angle.

11. The welding gun assembly of claim 9, wherein the contact tip cap is configured to hold the reversible contact tip such that the one of the first axial end portion or the second axial end portion in contact with the contact tip cap has an end surface that is substantially flush with an end surface of the contact tip cap.

12. The welding gun assembly of claim 9, wherein an inner surface of the contact tip cap is threaded, an outer surface of the contact tip holder is threaded, and the inner surface of the contact tip cap and the outer surface of the contact tip holder are configured to be connected to rigidly hold the reversible contact tip.

13. The welding gun assembly of claim 9, wherein the reversible contact tip further comprises a middle portion between the first axial end portion and the second axial end portion, the contact tip holder comprises first gas ports to permit gas flow into an annular region between the middle portion of the reversible contact tip and the contact tip cap, and the contact tip cap comprises second gas ports to permit gas flow from the annular region.

14. The welding gun assembly of claim 13, wherein the contact tip cap is configured such that gas flow from the contact tip holder to the second gas ports via the annular region removes heat from the reversible contact tip.

15. The welding gun assembly of claim 9, wherein the contact tip cap is configured to protect at least a portion of the first axial end portion or the second axial end portion in contact with the second seat.

16. The welding gun assembly of claim 9, wherein the contact tip holder and the contact tip cap are configured for toolless changing or installation of the reversible contact tip.

17. The welding gun assembly of claim 9, wherein the contact tip cap is configured to hold the reversible contact tip such that an end surface of the reversible contact tip exposed by the contact tip cap and having an opening of the inner bore is substantially flush with an end surface of the reversible contact tip.

18. The welding gun assembly of claim 9, wherein the reversible contact tip has reflectional symmetry across a plane perpendicular to the inner bore of the reversible contact tip.

19. The welding gun assembly of claim 9, further comprising a nozzle configured to connect the contact tip cap to the contact tip holder to force the contact tip cap toward the contact tip holder.

20. The welding gun assembly of claim 9, wherein the reversible contact tip comprises a shoulder configured to contact a corresponding shoulder on at least one of the first seat or the second seat.
